(19) United States
(12) Patent Application Publication
(10) Pub. No.: US 2008/0275113 A1
(43) Pub. Date: Nov. 6, 2008

(54) Antimicrobial Compositions, Products, And Methods Of Use

(76) Inventors: Thomas Edward Huetter, West Chester, OH (US); Thomas Alfred Inglin, Loveland, OH (US); Timothy Woodrow Coffindaffer, Maineville, OH (US); Kelly Lee Martin, Cincinnati, OH (US); Brian Gilbert Leukart, Cincinnati, OH (US); Dennis Eugene Kuhlman, Liberty Township, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/113,960

(22) Filed: May 2, 2008

Related U.S. Application Data
(60) Provisional application No. 60/927,742, filed on May 4, 2007.

(51) Int. Cl. A01N 31/08; A01N 55/02; A01P 1/00

(52) U.S. Cl. 514/494; 514/502; 514/736

(57) ABSTRACT

The present invention comprises an antimicrobial composition. More particularly to an antimicrobial composition that comprises a. from about 0.01% to about 15% of at least one non-anionic surfactant, by weight of the composition; b. from about 0.01% to about 15% of at least one acid, by weight of the composition; c. from about 0% to about 99.85% of water, by weight of the composition; and wherein the composition is foaming.

### CROSS REFERENCE TO RELATED APPLICATION

This application claims the benefit of U.S. Provisional Application No. 60/927,742, filed on May 4, 2007.

### FIELD OF THE INVENTION

The present invention relates to an antimicrobial composition. More particularly to an antimicrobial composition that comprises a. from about 0.01% to about 15% of at least one non-anionic surfactant, by weight of the composition; b. from about 0.01% to about 15% of at least one acid, by weight of the composition; c. from about 0% to about 99.85% of water, by weight of the composition; and wherein the composition is foaming.

Additionally the present invention relates to a device: comprising a composition contained in said device; wherein said composition comprising, a. from about 0.01% to about 15% of a non-anionic surfactant, by weight of the composition; b. from about 0.01% to about 15% of an acid, by weight of the composition; c. from about 0% to about 99.85% of water, by weight of the composition; and wherein the composition is foaming when dispensed.

### BACKGROUND OF THE INVENTION

Human and mammalian health is impacted by the spread of microbial entities at home, school, and work and in the environment generally. Indeed, viruses and bacteria continue to cause a variety of sicknesses and ailments, prompting high absenteeism in schools and places of employment. In the wake of SARS (severe acute respiratory syndrome), bird flu, widespread food poisoning and the like, the public has become even further concerned with sanitization, both of person and property. Consequently, there has been a thrust by the medical community to persuade the general public to wash any areas which generally come in contact with infected surfaces like body parts (e.g. hand washing), foods (e.g., uncooked meat, vegetables, fruits, etc.), cooking utensils, cooking surfaces (e.g., counter tops, sinks, etc.). It has been found that such methods are important in attempts to remove pathogenic microorganisms from human skin as well as other surfaces. As a result, those of skill in the art have focused their research endeavors on the identification and deployment of suitable antimicrobial compositions, and specifically those that provide immediate and residual kill of microbes, with or without the use of water.

There exist several contemporary compositions and methods for reducing and/or eliminating the growth of bacteria and/or viruses. For example, it is well known that the washing of hard surfaces, food (e.g. fruit or vegetables) and skin, especially the hands, with antimicrobial or non-medicated soap, is effective against viruses and bacteria. Removal of viruses and bacteria is often primarily due to the surfactancy of the soap and the mechanical action of the wash procedure, rather than the function of an antimicrobial agent. However, many conventional products and methods of sanitization, including washing, fail to address the dilemma of sanitization “on the go”, that is to say, when a consumer is removed from the benefit of running water. Those skilled in the art have attempted to resolve this dilemma via the incorporation of broad spectrum antimicrobial agents into disinfecting lotions, hand sanitizers, cleansing wipes and the like. Such articles reduce the need for water during or following the application of the subject composition. However, various leave-on hand sanitizers are not fully effective in that they lack residual efficacy. This has resulted in a return to the general recommendation that washing frequently with soap and water is still the best way to eliminate and prevent the spread of germs. Thus, it has been recommended that people continue to wash frequently to reduce the spread of viruses and bacteria.

Other conventional antimicrobial cleansing products include deodorant soaps, hard surface cleaners, and surgical disinfectants. These traditional, rinse-off antimicrobial products have been formulated to provide bacteria removal during washing. A few such products, including antimicrobial soaps, have also been shown to provide a residual effectiveness against Gram-positive bacteria, but provide limited residual effectiveness against Gram-negative bacteria. “Residual effectiveness” generally means that the subject antimicrobial controls microbial growth on a substrate by either preventing growth of microbes or engaging in continuous kill of microbes for some period of time following the washing and/or rinsing process. To address the dilemma of limited residual efficacy against Gram-negative bacteria, those skilled in the art have sought to incorporate high levels of harsh surfactants into contemporary antimicrobial products. However, such materials have been shown to cause dryness and irritation to skin tissues.

Thus, there remains a substantial need to identify and deploy antimicrobial compositions that may be used by consumers to provide immediate and residual kill of microbes with or without washing, minimize dryness and irritation to skin following application, and provide consumer acceptable aesthetics. Attempts to address the problems associated with dryness and irritation to the skin have generally resulted in the adoption of aqueous-based antimicrobial formulas incorporating high levels of surfactants that are too weak to provide significant immediate or residual benefits.

Since a substantial proportion of rhinovirus colds are transmitted by direct contact from virus-contaminated hands or objects, it is possible to lower the risk of acquiring infection by inactivating viruses on hands or surfaces. Hand washing is highly effective at disinfecting contaminated fingers but suffers from a lack of residual activity.

Thus, there remains a need for a stable antimicrobial composition that provides immediate and residual antimicrobial activity, does not dry or irritate the skin, does not have unpleasant aesthetics such as leaving unpleasant residue on the skin, and wherein the antimicrobial active is not lost in significant amounts over time during storage.

### SUMMARY OF THE INVENTION

The present invention comprises an antimicrobial composition comprising, a. from about 0.01% to about 15% of at least one non-anionic surfactant, by weight of the composition; b. from about 0.01% to about 15% of at least one acid, by weight of the composition; c. from about 0% to about 99.85% of water, by weight of the composition; and wherein the composition is foaming.

The present invention further relates to an antimicrobial composition comprising, a. at least one antimicrobial active; b. from about 0.01% to about 15% of at least one non-anionic surfactant, by weight of the composition; c. from about 0.01% to about 15% of at least one acid, by weight of the composition; d. from about 0% to about 99.85% of water, by weight of the composition; and wherein the composition is foaming.

The present invention further relates to a device: comprising a composition contained in said device; wherein said composition comprising, a. from about 0.01% to about 15% of at least one non-anionic surfactant, by weight of the composition; b. from about 0.01% to about 15% of an acid, by weight of the composition; c. from about 0% to about 99.85% of water, by weight of the composition.

The present invention further relates to a method of killing bacteria comprising the steps of; a) applying topically a safe and effective amount of the composition of Claim 1 to an area in need of treatment; and b) repeating said application as needed.

The present invention further relates to a method of inactivating viruses comprising the steps a) applying topically a safe and effective amount of the composition of Claim 1 to an area in need of treatment; and b) repeating said application as needed.

The present invention further relates to a method of preventing and/or treating bacteria and virus-related diseases in a mammal, comprising the steps of; a) applying topically a safe and effective amount of the composition of Claim 1 to an area of the user's skin which has contacted or is infected with a bacteria or a virus; and b) repeating said application as needed.

The present invention further relates to a method of sanitizing skin of a user, comprising the steps of: a) applying a safe and effective amount of the composition of Claim 1 to an area of the user's skin; b) spreading said composition substantially across user's skin where needed; and c) allowing said composition to dry and remain on user's skin.

### DETAILED DESCRIPTION OF THE INVENTION

The present invention comprises an antimicrobial composition comprising, a. from about 0.01% to about 15% of at least one non-anionic surfactant, by weight of the composition; b. from about 0.01% to about 15% of at least one acid, by weight of the composition; c. from about 0% to about 99.85% of water, by weight of the composition; and wherein the composition is foaming.

As used herein, “antimicrobial” includes antiviral, antibacterial, antifungal, antiyeast, and anti mold activities, both immediate and residual.

As used herein, “residual antiviral efficacy” means leaving a residue or imparting a condition on a keratinous tissue (e.g. skin) or other surfaces that remains effective and provides significant antiviral activity for some time after application. Preferably the compositions described herein exhibit residual antiviral efficacy such that a log 1.0 reduction, preferably a log 1.5 reduction, preferably a log 2.0 reduction, and preferably at least about a log 3.0 reduction in pathogenic viruses such as rhinovirus is maintained for at least about 0.25 hours, at least about 0.5 hours, at least about 1.0 hour, at least about 2 hours, for at least about 3 hours, for at least about 4 hours.

As used herein, “residual antibacterial efficacy” means leaving a residue or imparting a condition on a keratinous tissue (e.g., skin) or other surfaces that remains effective and provides significant antibacterial efficacy (specifically against gram positive and negative organisms). Preferably, the compositions described herein exhibit residual antibacterial efficacy such that at least about a log 1.0 reduction, at least about a log 1.5 reduction, and at least about a log 2.0 reduction in bacteria such as E. coli is maintained for at least about 0.5 hours, at least about 1 hour, at least about 2 hours, at least about 3 hours, at least about 4 hours.

As used herein, “safe and effective amount” means an amount of a compound, component, or composition (as applicable) sufficient to significantly induce a positive effect (e.g., germ kill) but low enough to avoid serious side effects (e.g., undue skin irritation).

The phrase “substantially free of” as used herein, means that the composition comprises less than about 3%, preferably less than about 1%, more preferably less than about 0.5%, even more preferably less than about 0.25%, and still more preferably less than about 0.1%, even still more preferably less than 0.01% by weight of the composition, of the stated ingredient.

As further used herein, “treatment” with respect to bacteria and virus-related diseases means that administration of the antimicrobial composition prevents, alleviates, ameliorates, inhibits, or mitigates the transmission of one or more bacteria and/or virus-related diseases and/or provides immediate and/or residual antimicrobial activity to the user that has topically applied the composition.

The present invention can also be directed to methods of “prevention” including inhibits, or mitigates the transmission of one or more bacteria and/or virus-related diseases and/or provides immediate and/or residual antimicrobial activity to the surface that has the composition topically applied by administering the antimicrobial composition to sanitize and/or cleanse the surface prior to exposure to one or more bacteria and/or virus-related diseases.

All weights, measurements and concentrations herein are measured at 25° C. on the composition in its entirety, unless otherwise specified.

These and other limitations of the compositions and methods of the present invention, as well as many of the optional ingredients suitable for use herein, are described in detail hereinafter.

All percentages, parts and ratios as used herein are by weight of the total composition, unless otherwise specified. All such weights as they pertain to listed ingredients are based on the active level and, therefore do not include solvents or by-products that may be included in commercially available materials, unless otherwise specified.

The composition and methods of the present invention can comprise, consist of, or consist essentially of, the essential elements and limitations of the invention described herein, as well as any additional or optional ingredients, components, or limitations described herein or otherwise useful in compositions intended for use by a mammal, preferably human use.

Composition

The present invention is an antimicrobial composition used by individuals preferably for cleansing and/or sanitizing the skin, hair, nails, or other similar keratin-containing surfaces of a mammal. The preferred pH range of the antimicrobial composition is from about 1 to about 7, from about 2 to about 6.5, from about 2 to about 5 and from about 2.6 to about 4.5.

The antimicrobial composition of the present invention can be liquid or semi-liquid, cream or mousse or gel or foaming compositions. The product forms contemplated for purposes of defining the compositions and methods of the present invention are typically leave on compositions, by which is meant the composition is applied topically to the mammal and then subsequently (i.e., within minutes) left on and/or not rinsed off and/or not wiped off. The antimicrobial composition can also be rinse-off, by which is meant the composition is applied topically to the mammal and then subsequently (i.e., within minutes) rinsed away with water, and/or otherwise wiped off using a substrate or other suitable removal means. Preferably the compositions are leave-on compositions. Antimicrobial composition is used herein to mean products suitable for application to a mammal's skin for the purpose of controlling the growth and viability of bacteria, viruses, fungi, yeasts and molds. Preferably, the antimicrobial compositions are mild, which means that these composition provides sufficient cleansing or sanitizing benefits but do not overly dry the mammal. The composition of the present invention can be contained in a device that can aid in providing a foaming composition when dispensed.

Non-Anionic Surfactant

The antimicrobial compositions of the present invention can comprise at least one non-anionic surfactant. The non-anionic surfactant comprises non-anionic surfactants suitable for application to the mammal. The non-anionic surfactant is selected from the group consisting of non-ionic surfactant, zwitterionic surfactants, cationic surfactant, amphoteric surfactants, and mixtures thereof.

When present, the antimicrobial composition comprises at least one non-anionic surfactant at concentrations ranging from about 0.01% to about 15%, from about 0.05% to about 13%, from about 0.1% to about 10%, from about 0.2% to about 9%, from about 1% to about 8%, and from about 1% to about 5%, by weight of the composition.

Non-Ionic Surfactants

The antimicrobial composition can comprise a non-ionic surfactant at concentrations ranging from about 0.01% to about 15%, from about 0.05% to about 13%, from about 0.1% to about 10%, from about 0.2% to about 9%, from about 0.25% to about 8%, from about 1% to about 8%, and from about 1.5% to about 5%, by weight of the composition.

Non-limiting examples of non-ionic surfactants for use in the compositions of the present invention are disclosed in McCutcheon's, Detergents and Emulsifiers, North American edition (1986), published by allured Publishing Corporation; and McCutcheon's, Functional Materials, North American Edition (1992).

Non-ionic surfactants useful herein include those selected from the group consisting of, amine oxides, alkyl glucosides, alkyl polyglucosides, polyhydroxy fatty acid amides, C₈-C₂₀ alkyl alkoxylated fatty acid esters, C₈-C₂₂ alkyl ethoxylated ester, C₈-C₂₀ alkyl ethoxylated fatty alcohols, C₈-C₂₀ alkyl sugar esters, C₈-C₂₀ alkyl phosphate esters, C₈-C₂₀ alkyl glycerol esters, ethoxylates, glycerides, and mixtures thereof. Nonlimiting examples include decyl glucoside polyethylene glycol 20 sorbitan monolaurate (Polysorbate 20), polyethylene glycol 5 soya sterol, Steareth-20, Ceteareth-20, PPG-2 methyl glucose ether distearate, Ceteth-10, Polysorbate 80, Polysorbate 60, glyceryl stearate, PEG-100 stearate, polyoxyethylene 20 sorbitan trioleate (Polysorbate 85), sorbitan monolaurate, polyoxyethylene 4 lauryl ether sodium stearate, polyglyceryl-4 isostearate, hexyl laurate, PPG-2 methyl glucose ether distearate, ceteth-10, glyceryl stearate, PEG-100 stearate, and mixtures. Preferably the non-ionic surfactant is C12 dimethylamine oxide.

Amphoteric Surfactants and/or Zwitterionic Surfactants

The antimicrobial composition can comprise an amphoteric surfactant at concentrations ranging from about 0.01% to about 15%, from about 0.05% to about 13%, from about 0.1% to habout 10%, from about 0.2% to about 9%, from about 0.75 to about 7, from about 0.75% to about 6%, and from about 0.75% to about 5%, by weight of the composition.

The antimicrobial composition can comprise a zwitterionic surfactant at concentrations ranging from about 0.01% to about 15%, from about 0.05% to about 13%, from about 0.1% to about 10%, from about 0.2% to about 9%, from about 0.25% to about 7%, from about 1% to about 6%, and from about 1% to about 5%, by weight of the composition.

A wide variety of amphoteric and/or zwitterionic surfactants can be used in the compositions of the present invention. Particularly useful are those which are broadly described as derivatives of aliphatic secondary and tertiary amines, preferably wherein the nitrogen is in a cationic state, in which the aliphatic radicals can be straight or branched chain and wherein one of the radicals contains an ionizable water solubilizing group, e.g., carboxy, sulfonate, sulfate, phosphate, or phosphonate.

Nonlimiting examples of amphoteric surfactants useful in the compositions of the present invention are disclosed in McCutcheon's, Detergents and Emulsifiers, North American edition (1986), published by allured Publishing Corporation; and McCutcheon's, Functional Materials, North American Edition (1992); both of which are incorporated by reference herein in their entirety.

Nonlimiting examples of amphoteric surfactants are those selected from the group consisting of betaines, sultaines, hydroxysultaines, alkyliminoacetates, iminodialkanoates, aminoalkanoates, and mixtures thereof.

Examples of betaines include the higher alkyl betaines, such as coco dimethyl carboxymethyl betaine, lauryl dimethyl carboxymethyl betaine, lauryl dimethyl alpha-carboxyethyl betaine, cetyl dimethyl carboxymethyl betaine, cetyl dimethyl betaine (available as Lonzaine 16SP from Lonza Corp.), lauryl bis-(2-hydroxyethyl)carboxymethyl betaine, oleyl dimethyl gamma-carboxypropyl betaine, lauryl bis-(2-hydroxypropyl)alpha-carboxyethyl betaine, coco dimethyl sulfopropyl betaine, lauryl dimethyl sulfoethyl betaine, lauryl bis-(2-hydroxyethyl)sulfopropyl betaine, amidobetaines and amidosulfobetaines (wherein the RCONH(CH₂)₃ radical is attached to the nitrogen atom of the betaine), oleyl betaine (available as amphoteric Velvetex OLB-50 from Henkel), and cocamidopropyl betaine (available as Velvetex BK-35 and BA-35 from Henkel).

For use herein are amphoteric surfactants having the following structure:

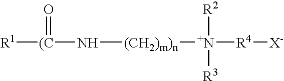

wherein R¹ is unsubstituted, saturated or unsaturated, straight or branched chain alkyl having from about 9 to about 22 carbon atoms. Preferred R¹ has from about 11 to about 18 carbon atoms; more preferably from about 12 to about 18 carbon atoms; more preferably still from about 14 to about 18 carbon atoms; m is an integer from 1 to about 3, more preferably from about 2 to about 3, and more preferably about 3; n is either 0 or 1, preferably 1; R² and R³ are independently selected from the group consisting of alkyl having from 1 to about 3 carbon atoms, unsubstituted or mono-substituted with hydroxy, preferred R² and R³ are CH₃; X is selected from the group consisting of CO₂, SO₃ and SO₄; R⁴ is selected from the group consisting of saturated or unsaturated, straight or branched chain alkyl, unsubstituted or monosubstituted with hydroxy, having from 1 to about 5 carbon atoms. When X is CO₂, R⁴ preferably has 1 or 3 carbon atoms, more preferably 1 carbon atom. When X is SO₃ or SO₄, R⁴ preferably has from about 2 to about 4 carbon atoms, more preferably 3 carbon atoms.

Examples of amphoteric surfactants of the present invention include the following compounds:

Cetyl dimethyl betaine (this material also has the CTFA designation cetyl betaine)

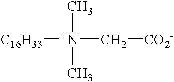

Cocamidopropylbetaine

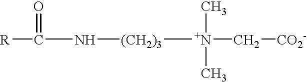

wherein R has from about 9 to about 13 carbon atoms

Examples of sultaines and hydroxysultaines include materials such as cocamidopropyl hydroxysultaine (available as Mirataine CBS from Rhodia).

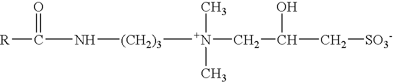

wherein R has from about 9 to about 13 carbon atoms,

Examples of other useful amphoteric surfactants are alkyliminoacetates, and iminodialkanoates and aminoalkanoates of the formulas RN[CH₂)ₘCO₂M]₂ and RNH(CH₂)ₘCO₂M wherein m is from 1 to 4, R is a C₈-C₂₂ alkyl or alkenyl, and M is H, alkali metal, alkaline earth metal ammonium, or alkanolammonium. Also included are imidazolinium and ammonium derivatives. Specific examples of suitable amphoteric surfactants include sodium 3-dodecyl-aminopropionate, sodium 3-dodecylaminopropane sulfonate, N-higher alkyl aspartic acids such as those produced according to the teaching of U.S. Pat. No. 2,438,091 which is incorporated herein by reference in its entirety; and the products sold under the trade name “Miranol” and described in U.S. Pat. No. 2,528,378, which is incorporated herein by reference in its entirety. Also useful are amphoacetates such as disodium lauroamphodiacetate, sodium lauroamphoacetate, and mixtures thereof.

Amphoacetates and diamphoacetates may also be used.

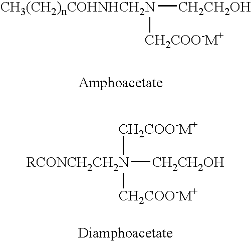

Amphoacetates and diamphoacetates conform to the formulas (above) where R is an aliphatic group of 8 to 18 carbon atoms. M is a cation such as sodium, potassium, ammonium, or substituted ammonium. Sodium lauroamphoacetate, sodium cocoamphoactetate, disodium lauroamphoacetate, and disodium cocodiamphoacetate are preferred in some embodiments. Zwitterionic surfactants suitable for use in the compositions include betaines, including high alkyl betaines such as coco dimethyl carboxymethyl betaine, cocoamidopropyl betaine, cocobetaine, lauryl amidopropyl betaine, oleyl betaine, lauryl dimethyl carboxymethyl betaine, lauryl dimethyl alphacarboxyethyl betaine, cetyl dimethyl carboxymethyl betaine, lauryl bis-(2-hydroxyethyl)carboxymethyl betaine, stearyl bis-(2-hydroxypropyl)carboxymethyl betaine, oleyl dimethyl gamma-carboxypropyl betaine, and lauryl bis-(2-hydroxypropyl)alpha-carboxyethyl betaine. The sulfobetaines may be represented by coco dimethyl sulfopropyl betaine, stearyl dimethyl sulfopropyl betaine, lauryl dimethyl sulfoethyl betaine, lauryl bis-(2-hydroxyethyl)sulfopropyl betaine and the like; amidobetaines and amidosulfobetaines, wherein the RCONH(CH₂)₃ radical is attached to the nitrogen atom of the betaine are also useful in this invention.

Cationic Surfactants

The antimicrobial composition can comprise a cationic surfactant at concentrations ranging from about 0.01% to about 15%, from about 0.05% to about 13%, from about 0.1% to about 10%, from about 0.2% to about 9%, from about 0.25% to about 7%, from about 1% to about 6%, and from about 1.5% to about 5%, by weight of the composition. Nonlimiting examples of cationic surfactants include esters derived from alkanolamines, dicarboxylic acids, fatty alcohols, quaternary ammonium compounds such as coamidopropyl PG-dimonium chloride phosphate (commercially available as Monaquat PTC, from Mona Corp.), and cocamidopropyl betainamide MEA chloride (commercially available as Montaline C40 from Seppic), and mixtures thereof.

Acid

The composition of the present invention can comprise at least one acid. Acids, for purposes of the present disclosure, are defined as proton-donating agents that remain at least partially dissociated in a concentrated composition. The acids disclosed herein facilitate the creation of a low pH buffer on the surface of a substrate (e.g. a product or the skin), thereby prolonging the residual antimicrobial activity of the compositions and products in which they are incorporated.

The antimicrobial compositions of the present invention can comprise at least one acid at concentrations from about 0.01% to about 15%, alternatively from about 0.02% to about 10%, alternatively from about 0.05% to about 7%, from about 1% to about 5%, by weight of the composition

Suitable acids of the present invention include, but are not limited to: pyroglutamic acid (PCA), adipic acid, gluconic acid, glyconolactone acid, glutamic acid, glycolic acid, glutaric acid, tartaric acid, ascorbic acid, citric acid, maleic acid, malic acid, succinic acid, benzoic acid, malonic acid, salicylic acid, polyacrylic acid, carboxymethylaspartic acid, copolymer of acrylic acid and maleic acid, oxydisuccinic acid, nitrilotriacetic acid, iminodisuccinic acid, tartrate disuccinic acid, tartrate monosuccinic acid, ethylenediaminetetraacetic acid, pyrophosphoric acid, straight-chain poly(acrylic) acids and copolymers thereof, cross-linked poly(acrylic) acids having a molecular weight of less than about 250,000, poly(α-hydroxy) acids and copolymers thereof, polysulfonic acid and copolymers thereof, carageenic acid, carboxy methyl cellulose, alginic acid; salts thereof and mixtures thereof. Preferably at least one acid is selected from the group consisting of pyroglutamic acid, succinic acid, glutaric acid, and mixtures thereof.

Antimicrobial Active

The antimicrobial composition of the present invention can comprise an antimicrobial active. The antimicrobial composition can comprise an antimicrobial active at concentrations of at least about 0.01%, alternatively from about 0.01% to about 15%, from about 0.05% to about 13%, from about 0.1% to about 10%, from about 0.2% to about 9%, from about 1% to about 8%, and from about 1.5% to about 5%, by weight of the composition. Nonlimiting examples of antimicrobial actives include triclocarban, triclosan, benzalkonium chloride, and mixtures thereof.

Volatile Solvent

The antimicrobial compositions of the present invention can also comprise a volatile solvent. This is advantageous to enable the composition to have substantial antimicrobial efficacy, and also to enable it to evaporate quickly from the surface to which it is applied leaving little or substantially no residue. Additionally, the volatile solvents can aid in preserving the composition. It is has been found that such compositions are useful for sanitizing the hands and other surfaces without the requirement for rinsing with water, and can therefore be used anywhere. Non-limiting examples of volatile solvents include monohydric linear and branched C₁ to C₆ alcohols or mixtures thereof. Non-limiting examples include ethanol, propanol, isopropanol, butanol, menthol, and mixtures thereof. Particularly useful with the compositions of the present invention is ethanol. The volatile solvents can be present at levels of from about 0.01% to about 95%, from about 0.01% to about 80%, from about 0.01% to about 60%, from about 0.01% to about 30%, from about 0.1% to about 25%, from about 1% to about 20%, from about 4% to about 15%, from about 8% to about 10%.

Liquid Carrier

The antimicrobial compositions of the present invention can comprise a liquid carrier material. The liquid carrier materials are selected from the group consisting of aqueous solvents, volatile solvents, and mixtures thereof. Example aqueous solvents include water. Where present, water is present in the antimicrobial compositions of the present invention at levels of from about 0% to about 99.85%, from about 10% to about 90%, from about 20% to about 80%, from about 25% to about 80%, by weight of the composition.

Additional Ingredients

The compositions of the present invention can comprise a wide range of additional ingredients. Nonlimiting examples of additional ingredients include antimicrobial metal salts, additional mildness enhancers, additional stabilizers, abrasives, anti-acne agents, antioxidants, biological additives, chemical additives, colorants, cosmetic astringents, coolants, chelants, denaturants, drug astringents, emulsifiers, external analgesics, film formers, fragrance compounds, humectants, opacifying agents, plasticizers, preservatives, propellants, reducing agents, skin bleaching agents, skin emollients, skin moisturizers, solvents, foam boosters, hydrotropes, solublizing agents, suspending agents (non-surfactant), sunscreen agents, a solvent, ultraviolet light absorbers, and viscosity increasing agents (aqueous and non-aqueous), sequestrants, vitamins, antioxidants, buffers, keratolytics, and the like, and combinations thereof. Preferably the additional ingredient is selected from the group consisting of solvents, a chelant, a preservative, a fragrance, buffer, antimicrobial metal salts and combinations thereof.

Nonlimiting examples of antimicrobial metal salts include zinc, iron, copper, silver, tin, bismuth, and combinations thereof.

Nonlimiting examples of preservative include but are not limited to benzoalkonium chloride, EDTA, benzyl alcohol, potassium sorbate, parabens, chlorhexidine gluconate, and mixtures thereof.

Device

The device of present invention preferably contains an antimicrobial composition of the present invention. Nonlimiting examples of the device of the present invention include a bottle, a canister, a container, a sachet, and combinations thereof. Preferably, the device is clear. Clear devices can include both colorless and colored which permits the user to see the composition through the device. The device can aid in providing a foaming composition when dispensed from the device.

The device comprises a material. The device can have a single chamber in which the composition is contained in and/or the device can have a dual chamber in which the composition can be contained in both chambers or individual ingredients that make up the composition can be separated and located in distinct chambers of the dual chamber device.

When the device is a sachet, the antimicrobial composition can deliver a single use event, and or a multiple use event for the consumer. In a preferred example the sachet comprises a sponge located within the sachet. Preferably the sponges are polymeric foam. Preferably the polymeric foam is open celled. The polymeric foam may be made from any suitable resilient, compressible, porous material. Preferably the polymeric foam is made from the material including but not limited to polyurethane, cellulose, and combinations thereof.

Nonlimiting examples of a material that can be used to make the device in the present invention include High Density Polyethylene (HDPE), Linear Low Density Polyethylene (LLDPE), Low Density Polyethylene (LDPE), Polyethylene (PE), Medium Density Polyethylene (MDPE), Polyethylene Terephthalate (PET), Glycol-modified Polyethylene Terephthalate (PETG), Polypropylene (PP), Polystyrene (PS), Polyethylene (PE), Oriented Polystyrene (OPS), Oriented Polypropylene (OPP), Thermoplastic Elastomer (TPE), Polyvinylchloride (PVC), Polyvinylidene Chloride (PVDC), Nylon, Polyethylene Terphthalate Polyester (PETP), Thermoplastic Elastomer (TPE), Thermoplastic Rubber (TPR), metallized films, Ethylene vinyl alcohol copolymer (EVOH), Polyphene, and combinations thereof. Preferably the material of the device is comprises material selected from the group consisting of Polyethylene Terephthalate (PET), Glycol-modified Polyethylene Terephthalate (PETG), Oriented Polypropylene (OPP), Polyvinylchloride (PVC), Polyvinylidene Chloride (PVDC), Nylon, Polyethylene Terphthalate Polyester (PETP), Polyphene, glass, metallized films and combinations thereof.

Methods of Use

The antimicrobial compositions of the present invention are suitable for a variety of uses. Suitable uses of the present compositions include, but certainly are not limited to, the eradication of viruses, bacteria; fungi, yeasts and mold, the provision of residual anti-viral efficacy; the provision of residual antibacterial efficacy; the prevention and/or treatment of infection by common cold, flu, or associated respiratory disease in a mammal; the prevention and/or treatment or transmission of a diarrhea in a mammal; the prevention and/or treatment and/or transmission of bacteria-related diseases in mammals resulting from contact with a bacteria-infected surface; the sanitization of hard surfaces; the improvement of the overall health of a mammal; the reduction of absenteeism; the prevention and/or treatment of dandruff and acne; and combinations thereof. It should be noted that, in the case of preventing or treating a common cold or respiratory disease, treatment with the compositions and products disclosed herein is effective when the cold or respiratory disease is caused by rhinovirus. It should be noted that, in the case of diarrhea, treatment with the present compositions and/or products is effective when the diarrhea is caused by rotavirus or bacteria.

In one aspect of the present invention, a method of killing bacteria is provided. The method comprises the steps of topically applying a safe and effective amount of the composition and/or product of the present invention to an area in need of treatment and, optionally, removing said composition and/or product following application. In another aspect of the present invention, a method of inactivating viruses is disclosed. The method, too, comprises the steps of topically applying a safe and effective amount the composition and/or product of the present invention to an area in need of treatment and, optionally, removing said composition and/or product following application. The method of inactivating viruses is useful in treating viruses selected from the group consisting of: rotavirus, rhinovirus and combinations thereof.

In one aspect of the present invention, a method of sanitizing skin of a user is provided. The method comprises the steps of topically applying a safe and effective amount of the composition and/or product of the present invention to an area of the user's skin and, spreading the composition substantially across the user's skin where needed; and allowing the composition to dry and remain on the user's skin, optionally, removing said composition and/or product following application. In another aspect of the present invention, a method of providing residual antibacterial and antiviral efficacy is provided. The method preferably comprises the steps of topically applying a safe and effective amount of the composition and/or product of the present invention to an area in need of treatment and, optionally, removing said composition following application. In yet another aspect of the present invention, a method of preventing and/or treating a respiratory disease or diarrhea in a mammal where the sickness is caused by a rhinovirus or rotavirus, respectively, is envisioned. The method comprises the steps of topically applying a safe and effective amount of the composition and/or products of the present invention to an area of the mammal in need of treatment and, optionally, removing said composition and/or product following application. Moreover, the present invention seeks to encompass a method of preventing and/or treating bacteria-related diseases in a mammal that result from the mammal's contact with a bacteria-infected substrate. The method comprises the steps of topically applying a safe and effective amount of the composition and/or product of the present invention to an area of the mammal that is infected with bacteria and, optionally, removing the composition and/or product following application.

Examples of areas and/or surfaces in need of treatment, against which the compositions of the present invention are effective, include, but are not limited to: one or more hands and/or feet, a nose, a nasal canal or passage, an ear or ear canal or passage, an article of clothing, a hard surface, irritated, acne-affected, or injured skin, pre- or post-surgical areas and combinations thereof.

The exact amount of antimicrobial composition and/or nature of a product used will depend upon the needs and abilities of the formulator and practitioner of the present methods. Nevertheless, when the antimicrobial compositions or products of the present invention are topically applied to keratinous surfaces, they are applied in doses of from about 0.1 mL or 0.1 g to about 5 mL or 5 g per use, from about 0.4 mL or 0.4 g to about 4 mL or 4 g, from about 0.4 mL or 0.4 g to about 2 mL or 2 g of the composition. For children's hands, the applied amount can be approximately one-half of the amount applied to adult hands, however, children can also receive the same amount as adults. Moreover, the compositions and products of the present invention are topically applied to surfaces in need of treatment from about 2 to about 6 times daily. Once applied, the compositions are rubbed on the treated surfaces for a period of time to ensure coverage, typically at most for about 30 seconds, or for about 20 seconds, or for about 10 seconds, or for about 5 seconds.

### EXAMPLES

The following examples further describe and demonstrate embodiments within the scope of the present invention. They are given for the purpose of illustration and are not to be construed as limitations of the present invention.

### Example 1-6

### Examples Example 1 Example 2 Example 3 Example 4

Wt. % Wt. % Wt. % Wt. %
Water 78.076 77.757 78.076 77.576
Ethanol 8.000 8.000 8.000 8.000
Pyroglutamic acid 4.200 4.200 4.200 4.200
Succinic acid 2.290 2.290 0.000 2.290
Disodium succinate hexahydrate 1.176 1.176 0.000 1.176
Salicylic acid 0.000 0.000 2.290 0.000
Sodium salicylate 0.000 0.000 1.176 0.000
Polyquaternium-10 0.025 0.000 0.025 0.025
Aloe vera gel 1.000 1.000 1.000 1.000
Cocamidopropyl hydroxysultaine (50%) 1.500 0.000 1.500 1.500
C12 dimethyl amine oxide (32%) 0.781 3.125 0.781 0.781
Cocamidopropyl betainamide MEA chloride (40%) 2.500 0.000 2.500 2.500
Decyl glucoside (50%) 0.000 2.000 0.000 0.000
Cucumber mint 0.032 0.032 0.032 0.032
Triclosan 0.210 0.210 0.210 0.210
Zinc acetate 0.000 0.000 0.000 0.500
Potassium sorbate 0.100 0.100 0.100 0.100
Benzyl alcohol 0.100 0.100 0.100 0.100
Disodium EDTA 0.010 0.010 0.010 0.010

Example 5 Example 6
wt. % wt. %
Water 78.286 77.576
Ethanol 8.000 8.000
Pyroglutamic acid 4.200 4.200
Succinic acid 2.290 2.290
Disodium succinate hexahydrate 1.176 1.176
Salicylic acid 0.000 0.000
Sodium salicylate 0.000 0.000
Polyquaternium-10 0.025 0.025
Aloe vera gel 1.000 1.000
Cocamidopropyl hydroxysultaine (50%) 1.500 1.500
C12 dimethyl amine oxide (32%) 0.781 0.781
Cocamidopropyl betainamide MEA chloride (40%) 2.500 2.500
Decyl glucoside (50%) 0.000 0.000
Cucumber mint 0.032 0.032
Triclosan 0.000 0.210
Zinc acetate 0.000 0.000
Stannous gluconate 0.000 0.500
Potassium sorbate 0.100 0.100
Benzyl alcohol 0.100 0.100
Disodium EDTA 0.010 0.010
   Examples 1-6 can be made by first adding water to a tank. Ingredients such as acids/buffers, polyquaternium-10, potassium sorbate, disodium EDTA, zinc acetate are added and dissolved in the tank with water. Next, ingredients benzyl alcohol and aloe vera gel are added to the tank. Non-anionic surfactant are then added and blended. A premix of ethanol, fragrance and triclosan if present is prepared. The premix is added to the tank and the composition is mixed until homogeneous. The compositions are then placed into a device.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An antimicrobial composition comprising,
a. from about 0.01% to about 15% of at least one non-anionic surfactant, by weight of the composition;
b. from about 0.01% to about 15% of at least one acid, by weight of the composition;
c. from about 0% to about 99.85% of water, by weight of the composition; and
wherein the composition is foaming.

2. The composition of claim 1, wherein said composition is selected from the group consisting of a leave-on composition, a rinse-off composition, and combinations thereof.

3. The composition of claim 1, further comprises an antimicrobial active.

4. The composition of claim 3, further comprises at least about 0.01% of said antimicrobial active, by weight of the composition.

5. The composition of claim 3, wherein said antimicrobial active is selected from the group consisting of triclocarban, triclosan, benzalkonium chloride, and mixtures thereof.

6. The composition of claim 1, wherein said acid is selected from the group consisting of succinic acid, pyroglutamic acid, glutaric acid, and mixture thereof.

7. The composition of claim 1, wherein said non-anionic surfactant is selected from the group consisting of non-ionic surfactant, zwitterionic surfactant, cationic surfactant, amphoteric surfactant, and mixtures thereof.

8. The composition of claim 7, wherein said non-ionic surfactant is selected from the group consisting of amine oxides, alkyl glucosides, alkyl polyglucosides, polyhydroxy fatty acid amides, C₈-C₂₀ alkyl alkoxylated fatty acid esters, C₈-C₂₂ alkyl ethoxylated ester, C₈-C₂₀ alkyl ethoxylated fatty alcohols, C₈-C₂₀ alkyl sugar esters, C₈-C₂₀ alkyl phosphate esters, C₈-C₂₀ alkyl glycerol esters, ethoxylates, glycerides, and mixtures thereof

9. The composition of claim 7, wherein said amphoteric surfactant is selected from the group consisting of betaines, sultaines, hydroxysultaines, alkyliminoacetates, iminodialkanoates, aminoalkanoates, and mixtures thereof.

10. The composition of claim 7, wherein said cationic surfactant is selected from the group consisting of esters derived from alkanolamines, dicarboxylic acids, fatty alcohols, quaternary ammonium compounds, and mixtures thereof.

11. The composition of claim 1, wherein said composition has a pH of from about 1 to about 7.

12. The composition of claim 1, wherein said composition has a pH of from about 2 to about 6.5.

13. The composition of claim 1, wherein said composition has a pH of from about 2 to about 5.

14. The composition of claim 1, further comprising from about 0.01% to about 95% of a volatile solvent, by weight of the composition.

15. The composition of claim 14, from about 0.01% to about 80% of a volatile solvent, by weight of the composition.

16. The composition of claim 1, further comprising an additional ingredient selected from the group consisting of antimicrobial metal salts, additional mildness enhancers, additional stabilizers, abrasives, anti-acne agents, antioxidants, biological additives, chemical additives, colorants, chelants, cosmetic astringents, coolants, denaturants, drug astringents, emulsifiers, external analgesics, film formers, fragrance compounds, humectants, opacifying agents, plasticizers, preservatives, propellants, reducing agents, skin bleaching agents, skin emollients, skin moisturizers, solvents, foam boosters, hydrotropes, solublizing agents, suspending agents (non-surfactant), sunscreen agents, a salt, a solvent, ultraviolet light absorbers, and viscosity increasing agents (aqueous and non-aqueous), sequestrants, vitamins, antioxidants, buffers, keratolytics, and the like, and combinations thereof.

17. The composition of claim 16, wherein said antimicrobial metal salts is selected from the group consisting of zinc, iron, copper, silver, tin, bismuth, and combinations thereof.

18. The composition of claim 16, wherein said preservative is selected from the group consisting of benzoalkonium chloride, EDTA, potassium sorbate, benzyl alcohol, parabens, chlorhexidine gluconate, and combinations thereof

19. An antimicrobial composition comprising,
a. at least one antimicrobial active;
b. from about 0.01% to about 15% of at least one non-anionic surfactant, by weight of the composition;
c. from about 0.01% to about 15% of at least one acid, by weight of the composition;
d. from about 0% to about 99.85% of water, by weight of the composition; and
wherein the composition is foaming.

20. The composition of claim 19, wherein said composition is selected from the group consisting of a leave-on composition, a rinse-off composition, and combinations thereof.

21. The composition of claim 19, wherein said composition comprises at least about 0.01% of said antimicrobial active, by weight of the composition.

22. The composition of claim 19, wherein said antimicrobial active is selected from the group consisting of triclocarban, triclosan, benzalkonium chloride, and mixtures thereof.

23. The composition of claim 19, wherein said acid is selected from the group consisting of succinic acid, pyroglutamic acid, glutaric acid, and mixture thereof.

24. The composition of claim 19, wherein said non-anionic surfactant is selected from the group consisting of non-ionic surfactant, zwitterionic surfactant, cationic surfactant, amphoteric surfactant, and mixtures thereof.

25. The composition of claim 24, wherein said non-ionic surfactant is selected from the group consisting of amine oxides, alkyl glucosides, alkyl polyglucosides, polyhydroxy fatty acid amides, C₈-C₂₀ alkyl alkoxylated fatty acid esters, C₈-C₂₂ alkyl ethoxylated ester, C₈-C₂₀ alkyl ethoxylated fatty alcohols, C₈-C₂₀ alkyl sugar esters, C₈-C₂₀ alkyl phosphate esters, C₈-C₂₀ alkyl glycerol esters, ethoxylates, glycerides, and mixtures.

26. The composition of claim 24, wherein said amphoteric surfactant is selected from the group consisting of betaines, sultaines, hydroxysultaines, alkyliminoacetates, iminodialkanoates, aminoalkanoates, and mixtures thereof.

27. The composition of claim 19, wherein said composition has a pH of from about 1 to about 7.

28. The composition of claim 19, further comprising from about 0.01% to about 95% of a volatile solvent, by weight of the composition.

29. The composition of claim 19, further comprising an additional ingredient selected from the group consisting of antimicrobial metal salts, additional mildness enhancers, additional stabilizers, abrasives, anti-acne agents, antioxidants, biological additives, chemical additives, colorants, cosmetic astringents, coolants, chelants, denaturants, drug astringents, emulsifiers, external analgesics, film formers, fragrance compounds, humectants, opacifying agents, plasticizers, preservatives, propellants, reducing agents, skin bleaching agents, skin emollients, skin moisturizers, solvents, foam boosters, hydrotropes, solublizing agents, suspending agents (non-surfactant), sunscreen agents, a salt, a solvent, ultraviolet light absorbers, and viscosity increasing agents (aqueous and non-aqueous), sequestrants, vitamins, antioxidants, buffers, keratolytics, and the like, and combinations thereof.

30. A device: comprising a composition contained in said device; wherein said composition comprising,
a. from about 0.01% to about 15% of at least one non-anionic surfactant, by weight of the composition;
b. from about 0.01% to about 15% of an acid, by weight of the composition;
c. from about 0% to about 99.85% of water, by weight of the composition.

31. The device of claim 30, wherein said device comprises material selected from the group consisting of High Density Polyethylene (HDPE), Linear Low Density Polyethylene (LLDPE), Low Density Polyethylene (LDPE), Polyethylene (PE), Medium Density Polyethylene (MDPE), Polyethylene Terephthalate (PET), Glycol-modified Polyethylene Terephthalate (PETG), Polypropylene (PP), Polystyrene (PS), Polyethylene (PE), Oriented Polystyrene (OPS), Oriented Polypropylene (OPP), Thermoplastic Elastomer (TPE), Polyvinylchloride (PVC), Polyvinylidene Chloride (PVDC), Nylon, Polyethylene Terphthalate Polyester (PETP), Thermoplastic Elastomer (TPE), Thermoplastic Rubber (TPR), metallized films, Ethylene vinyl alcohol copolymer (EVOH), Polyphene, and combinations thereof.

32. The device of claim 30, wherein said device comprises material selected from the group consisting of Polyethylene Terephthalate (PET), Glycol-modified Polyethylene Terephthalate (PETG), Oriented Polypropylene (OPP), Polyvinylchloride (PVC), Polyvinylidene Chloride (PVDC), Nylon, Polyethylene Terphthalate Polyester (PETP), metallized films, Polyphene, and combinations thereof.

33. The device of claim 30, wherein said composition is selected from the group consisting of a leave-on composition, a rinse-off composition, and combinations thereof.

34. The device of claim 30, further comprises an antimicrobial active.

35. The device of claim 30, further comprises at least about 0.01% of said antimicrobial active, by weight of the composition.

36. The device of claim 30, wherein said antimicrobial active is selected from the group consisting of triclocarban, triclosan, benzalkonium chloride, and mixtures thereof.

37. The device of claim 30, wherein said acid is selected from the group consisting of succinic acid, pyroglutamic acid, glutaric acid, and mixture thereof.

38. The device of claim 30, wherein said non-anionic surfactant is selected from the group consisting of non-ionic surfactant, zwitterionic surfactant, cationic surfactant, amphoteric surfactant, and mixtures thereof.

39. The device of claim 38, wherein said non-ionic surfactant is selected from the group consisting of amine oxides, alkyl glucosides, alkyl polyglucosides, polyhydroxy fatty acid amides, C₈-C₂₀ alkyl alkoxylated fatty acid esters, C₈-C₂₂ alkyl ethoxylated ester, C₈-C₂₀ alkyl ethoxylated fatty alcohols, C₈-C₂₀ alkyl sugar esters, C₈-C₂₀ alkyl phosphate esters, C₈-C₂₀ alkyl glycerol esters, ethoxylates, glycerides, and mixtures thereof.

40. The device of claim 38, wherein said amphoteric surfactant is selected from the group consisting of betaines, sultaines, hydroxysultaines, alkyliminoacetates, iminodialkanoates, aminoalkanoates, and mixtures thereof.

41. The device of claim 38, wherein said cationic surfactant is selected from the group consisting of esters derived from alkanolamines, dicarboxylic acids, fatty alcohols, quaternary ammonium compounds, and mixtures thereof.

42. The device of claim 30, wherein said composition has a pH of from about 1 to about 7.

43. The device of claim 30, further comprising from about 0.01% to about 95% of a volatile solvent, by weight of the composition.

44. The device of claim 30, further comprising an additional ingredient selected from the group consisting of antimicrobial metal salts, additional mildness enhancers, additional stabilizers, abrasives, anti-acne agents, antioxidants, biological additives, chemical additives, colorants, cosmetic astringents, coolants, chelants, denaturants, drug astringents, emulsifiers, external analgesics, film formers, fragrance compounds, humectants, opacifying agents, plasticizers, preservatives, propellants, reducing agents, skin bleaching agents, skin emollients, skin moisturizers, solvents, foam boosters, hydrotropes, solublizing agents, suspending agents (non-surfactant), sunscreen agents, a salt, a solvent, ultraviolet light absorbers, and viscosity increasing agents (aqueous and non-aqueous), sequestrants, vitamins, antioxidants, buffers, keratolytics, and the like, and combinations thereof.

45. The device of claim 30, wherein said device is selected from the group consisting of a bottle, a canister, a container, a sachet, and combinations thereof.

46. The device of claim 30, wherein said device is clear.

47. A method of killing bacteria comprising the steps of; a) applying topically a safe and effective amount of the composition of claim 1 to an area in need of treatment; and b) repeating said application as needed.

48. A method of inactivating viruses comprising the steps a) applying topically a safe and effective amount of the composition of claim 1 to an area in need of treatment; and b) repeating said application as needed.

49. A method of preventing and/or treating and/ or reducing the transmission of bacteria and virus-related diseases in a mammal, comprising the steps of; a) applying topically a safe and effective amount of the composition of claim 1 to an area of the user's skin which has contacted or is infected with a bacteria or a virus; and b) repeating said application as needed.

50. A method of sanitizing skin of a user, comprising the steps of: a) applying a safe and effective amount of the composition of claim 1 to an area of the user's skin; b) spreading said composition substantially across user's skin where needed; and c) allowing said composition to dry and remain on user's skin.
